(19) United States
(12) Patent Application Publication
(10) Pub. No.: US 2012/0187938 A1
(43) Pub. Date: Jul. 26, 2012

(54) FLOW CHAMBER HAVING A CELL-GUIDING DEVICE

(75) Inventors: Ludwig Bär, Erlangen (DE); Helmut Eckert, Rottenbach (DE); Oliver Hayden, Herzogenaurach (DE); Sandro Francesco Tedde, Erlangen (DE); Michael Vieth, Mohrendorf (DE); Roland Weiss, Erlangen (DE)

(73) Assignee: Siemens Aktiengesellschaft, Munich (DE)

(21) Appl. No.: 13/499,613

(22) PCT Filed: Aug. 17, 2010
(86) PCT No.: PCT/EP2010/061931

§ 371 Date: Mar. 30, 2012

(30) Foreign Application Priority Data
Sep. 30, 2009 (DE) 10 2009 047 801.9

(51) Int. Cl. G01N 27/74

(52) U.S. Cl. 324/204

(57) ABSTRACT

A flow cytometer has a flow chamber in which labeled cells are highly likely to be detected by a corresponding sensor as a medium carrying the magnetically labeled cells flows through the flow chamber. The flow chamber has at least one sensor positioned on an inner surface thereof to detect the cells. The flow chamber also has a magnetic or magnetizable cell guiding device which can be positioned upstream of the sensor in the direction of flow to guide the flowing, magnetically labeled cells directly across the sensor, so that only a small percentage of labeled cells pass outside of the reach of the sensor.

### CROSS REFERENCE TO RELATED APPLICATIONS

This application is the U.S. national stage of International Application No. PCT/EP2010/061931, filed Aug. 17, 2010 and claims the benefit thereof. The International Application claims the benefit of German Application No. 10 2009 047 801.9 filed on Sep. 30, 2009; both applications are incorporated by reference herein in their entirety.

### BACKGROUND

Described below is a flow chamber of a flow cytometer, in which labeled cells may be detected with a high level of probability with the assistance of an appropriate sensor.

In a magnetic flow cytometer, labeled cells which are to be detected with the assistance of appropriate sensors must be conveyed close above the surface of a sensor in a flow chamber. For example, GMR (giant magnetoresistance) sensors or optical fluorescence or scattered light sensors are used for this purpose. The cell must be close to the sensor, since for example in the case of a GMR sensor the magnetic scatter field of the magnetic labels, which is ultimately utilized by the GMR sensor for detection, declines with the cube of distance from the sensor. The same applies to optical measurement methods.

In order to ensure that a labeled cell passes by in the immediate vicinity of the sensor, it is in principle conceivable to make the diameter of the channel through which the medium carrying labeled cells flows as small as possible, i.e. in an extreme case the diameter of the channel is just big enough for individual cells to be able to pass through. The drawback of this approach is of course that the presence of impurities or disruptive particles very rapidly results in the channel being blocked. On the other hand, if the channel is made larger, there is also a greater probability that individual labeled cells will pass by outside the range of the sensor and will thus not be detected. This drawback may be countered by providing a larger number of sensors, but this entails more complex electronics.

### SUMMARY

Described below is a flow chamber in which there is an elevated probability of detecting a labeled cell with a sensor of the flow chamber. Through the flow chamber in a flow cytometer flows a medium carrying magnetically labeled cells. The flow chamber has at least one sensor for cell detection positioned on an internal surface of the flow chamber, and is equipped with a magnetic or magnetizable cell-guiding device. The latter is positioned upstream of the sensor in the direction of flow and arranged and constructed there such that it guides the flowing, magnetically labeled cells over the sensor.

The cell-guiding device is advantageously arranged on the internal surface of the flow chamber and includes a number n, with n≧1, of magnetic or magnetizable flow strips oriented substantially parallel to the direction of flow, wherein
the number n of flow strips corresponds to the number of sensors,
one flow strip is in each case assigned to one sensor and
a magnetically labeled cell guided by a flow strip is guided over the assigned sensor.

In a first embodiment, a flow strip is of a width which remains constant throughout in the direction of flow.

In a second embodiment, a flow strip tapers in the direction of flow, in particular in the manner of a funnel or half funnel.

In a third embodiment, an individual, wide flow strip divides, in the direction of flow, into a plurality of narrower, substantially parallel flow sub-strips, wherein the number of flow sub-strips corresponds to the number of sensors.

In a fourth embodiment, the flow strips are arranged in a herringbone pattern.

In an advantageous embodiment, part of a flow strip, in particular the downstream part in the direction of flow, is subdivided into a plurality of portions lying downstream of one another and spaced apart from one another.

In an advantageous embodiment, a magnet is provided which is arranged in such a manner on the flow chamber that a force directed towards the internal surface is generated which acts on the magnetically labeled cells.

In a further advantageous embodiment, the sensor is a GMR sensor.

In a further embodiment, a further magnetic or magnetizable cell-guiding device is provided which is positioned downstream of the sensor in the direction of flow.

In the method, magnetically labeled cells in a medium flowing through a flow chamber of a flow cytometer are detected with a sensor by guiding the flowing, labeled cells over the sensor with a magnetic or magnetizable cell-guiding device, which is positioned upstream of the sensor in the direction of flow.

In an advantageous further embodiment of the method, a further cell-guiding device is used, which is arranged downstream of the sensor in the direction of flow. The medium is guided over the sensor alternately in a first direction and in a second direction, which is contrary to the first direction.

### BRIEF DESCRIPTION OF THE DRAWINGS

These and other aspects and advantages will become more apparent and more readily appreciated from the exemplary embodiments described below with reference to the accompanying drawings of which:

FIG. 1 is a cross-section of a flow chamber,

FIG. 2 is a plan view of a first embodiment of the cell-guiding device,

FIG. 3 is a plan view of a second embodiment of the cell-guiding device,

FIG. 4 is a plan view of a third embodiment of the cell-guiding device,

FIG. 5 is a plan view of a fourth embodiment of the cell-guiding device,

FIG. 6 is a plan view of a fifth embodiment of the cell-guiding device,

FIG. 7 is a plan view of a further embodiment of the cell-guiding device,

FIGS. 8A-8C and 8A′-8C′ are plan views and side views, respectively, of three embodiments of the flow strip and

FIGS. 9A-9C are side views illustrating the principle of cell concentration.

### DETAILED DESCRIPTION OF THE PREFERRED EMBODIMENT

In the figures, identical or mutually corresponding zones, components, and component assemblies are designated with the same reference numerals.

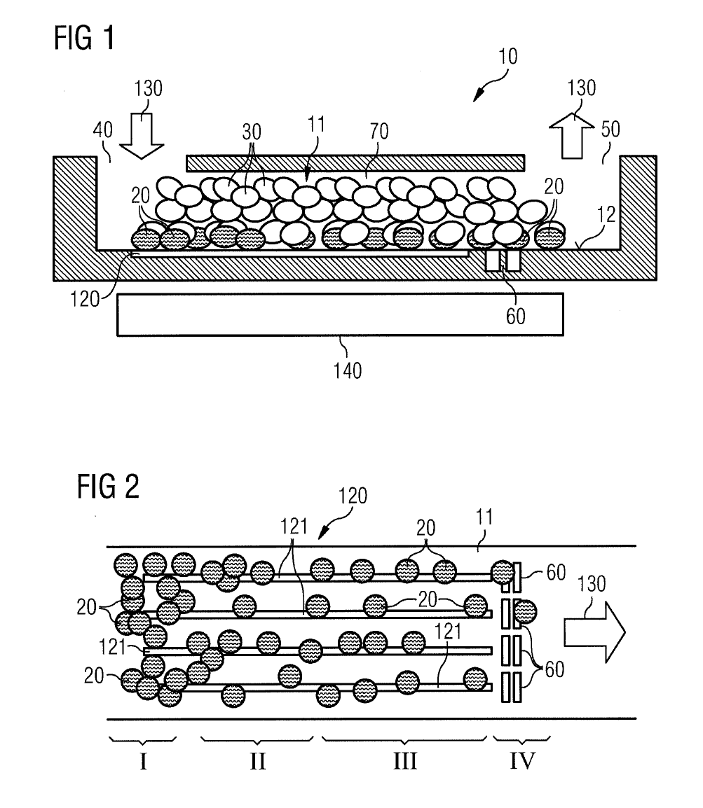

FIG. 1 shows a flow chamber 10 of a flow cytometer in cross-section. A medium 70, which contains the magnetically labeled cells 20 to be detected as well as unlabeled cells 30, passes in the direction of flow 130 through an orifice 40 into the flow chamber 10. The medium 70 flows through a microfluidic channel 11 of the chamber 10 and, after detection, leaves the latter through a further orifice 50. The magnetically labeled cells 20 are detected with the aid of a sensor 60. The sensor 60 may for example be a GMR sensor or an optical fluorescence or scattered light sensor. By way of example below, it is assumed that a GMR sensor 60 is used.

FIG. 1 likewise shows an optional permanent magnet 140, which is located below the microfluidic channel 11 and which generates a magnetic field (not shown). This field on the one hand attracts the magnetically labeled cells 20, so ensuring that they brush over the sensor 60 close to the surface thereof. On the other hand, the magnet 140, especially in the case assumed here of a sensor 60 of the GMR type, may be used in order to generate the gradient field required for operation of this type of sensor; when the magnetic cells 20 pass over the GMR sensor 60 they influence the magnetic field prevailing at the location of the sensor. This is recorded by the GMR sensor and utilized for detection. Alternatively, a corresponding energized coil may of course also be used instead of the permanent magnet 140. In the event that the sensor 60 is an optical fluorescence or scattered light sensor or the like, a magnetic field is, of course, not required for sensor operation. Nevertheless a magnet may also be provided in order, as mentioned, to ensure that the labeled cells 20 pass close over the surface of the sensor 60.

When dimensioning the magnet 140, care must be taken to ensure that the strength of the magnetic field is matched to the flow velocity of the medium. If the magnetic field and thus the retention force is too strong, disruption to flow cannot be ruled out as individual cells 20 may possibly be immobilized. Conversely, if the magnetic field is too weak, it is to be assumed that some of the labeled cells 20 will pass by the sensor 60 outside the range thereof, i.e. that they will not be detected.

By way of the interplay between the strength of the magnetic field of the magnets 140 and the flow 130, generated for example by pumps (not shown), or the velocity thereof, it is possible purposefully to adjust the retention force for magnetically labeled cells 20 in order, on the one hand, to remove cells with low labeling density, i.e. “false positive” cells, and, on the other hand, only to convey cells with sufficiently strong immunomagnetic labeling to the sensor 60, with any unbound labels, for example superparamagnetic particles, not being conveyed to the sensor due to the lower retention force.

In a concentration device not shown in FIG. 1, which is described in greater detail in FIG. 8, the medium 70 may initially be concentrated before the actual detection, i.e. the concentrated medium 70 leaving the concentration device would enter the flow chamber 10 via the orifice 40.

The flow chamber 10 includes a cell-guiding device 120. This device 120 ensures that the magnetically labeled cells 20 which are still stochastically distributed at the inlet 40 to the flow chamber 10, (cf. FIGS. 2 to 6) can be purposefully guided over the sensor 60. This has the advantageous consequence that a substantially larger number of cells 20 may be detected, since distinctly fewer cells flow past, for example to the side of, the sensor 60. It is accordingly no longer left to chance whether a labeled cell 20 comes within the range of the sensor 60 and is detectable.

To this end, magnetic or magnetizable metal tracks are arranged in the direction of flow on or in that internal surface 12 of the flow chamber 10 on which the sensor 60 is also arranged. As is explained below with reference to the figures, these metal tracks or “flow strips” may for example be of constant width, taper in the manner of a funnel or half funnel, converge in a fan shape or also be arranged in a herringbone pattern. Others arrangements which likewise ensure that the labeled cells 20 are guided over the sensor 60 are, of course, likewise conceivable. The flow strips may furthermore be of continuous or alternatively of discontinuous design. A discontinuous design (cf. FIG. 8B, 8C) singulates the cells 20, i.e. it is ensured that a plurality of cells 20 do not brush over the sensor 60 simultaneously or immediately one after the other. Because individual cells 20 now brush over the sensor 60, it is ensured that individual cell analysis may be carried out more efficiently.

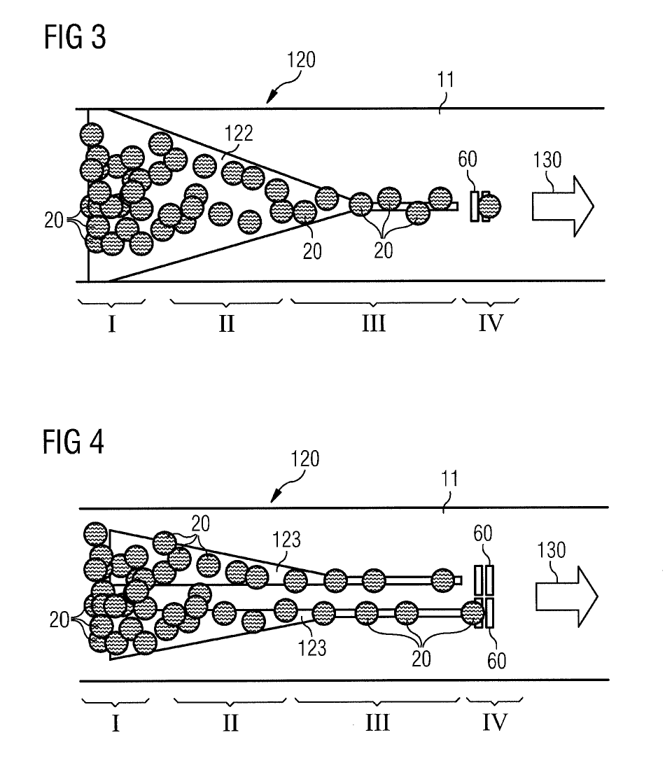

FIG. 2, like FIGS. 3, 4, 5 and 6, shows a plan view of the interior of a flow chamber 10, the unlabeled cells 30 not being shown for the sake of clarity. For the same reason, only a few of the cells 20 are provided by way of example with reference numerals. In this exemplary embodiment, the cell-guiding device 120 has four flow strips 121 made of a magnetic or a magnetizable material. The flow strips 121 are arranged parallel to one another and are oriented in the direction of flow 130 of the medium. The width of the flow strips 121 may be substantially in line with the diameter of the cells 20, but is however generally less than the width of the sensors 60.

The interaction between the magnetic cells 20 and the magnetic flow strip 121 ensures that the cells 20, as they flow past the strips 120 with the medium 70, leave their stochastic distribution and arrange themselves on the strips 121:
in a first zone I, the cells 20 are stochastically distributed.
in a second zone II, the cells 20 align themselves with the flow strip 121.
in a third zone III, the cells 20 arranged on the flow strip 121 are conveyed to the sensors 60.
in a fourth zone IV, (individual) cell detection takes place.

The boundaries of zones I to IV are here not sharply defined, but are instead variable, for example, as a function of the field of the magnet 140 and the flow velocity. In other words, the zones shown in the figures should be understood as examples.

Because the magnetic gradient is steepest at the edge of the respective flow strip 121, it is to be assumed that the cells 20 will not arrange themselves centrally on the respective flow strip 121, but instead on the edge thereof.

In the direction of flow downstream of each flow strip 121, i.e. as an extension of the strip 121, there is located a sensor 60, such that the labeled and ordered cells 20 may be purposefully guided over the sensor 60 with the assistance of the cell-guiding device 120. Apart from a few exceptions, which were not caught by the magnetic flow strip 121 and were therefore not guided to the sensors 60, it may be assumed that a large proportion of the labeled cells 20 in the medium 70 will come within the range of the sensors 60, such that a substantially higher yield may be achieved with the arrangement, which is for example manifested, with constant statistics, in a shorter measurement time or, with a constant measurement time, in improved statistics.

The flow strips may for example be made of nickel and be ≦10 μm wide and 100-500 nm thick. Thicknesses of an order of magnitude of 1 μm are, however, likewise conceivable. The microfluidic channel 11 is typically 100-400 μm wide, 100 μm high and approx. 1 mm long. The GMR sensors 60 are approx. 25-30 μm long (in a direction perpendicular to the direction of flow 130).

FIG. 3 shows a further exemplary embodiment of a cell-guiding device 120. In this case, the cell-guiding device 120 has only one flow strip 122, which however tapers in the manner of a funnel in the direction of flow 130 until it is ultimately of a width which approximately corresponds to the diameter of the cells 20. At its wide end, the strip 122 covers the entire width of the flow cell 10 or of the microfluidic channel 11. This wide zone of the strip virtually acts as a collector with which the cells 20 may be led towards the narrow flow strip.

In this exemplary embodiment too, the flow strip 122 may be made of a magnetic or a magnetizable material, such that here too the initially stochastically distributed, magnetically labeled cells 20 may be ordered and finally guided over the sensor 60.

The advantage of the arrangement of FIG. 3 over that of FIG. 2 is, for example, that in this case only one sensor 60 is required. This permits simplification of the readout electronics.

In a third exemplary embodiment of the cell-guiding device 120 which is shown in FIG. 4, the latter is formed of two magnetic or magnetizable flow strips 123, which in each case taper in the manner of a half funnel in the direction of flow 130. As in the other exemplary embodiments, in this case too a sensor 60 is assigned to each flow strip 123, which sensor is located in the direction of flow 130 downstream of the flow strip 123 and over which the labeled cells 20 are guided.

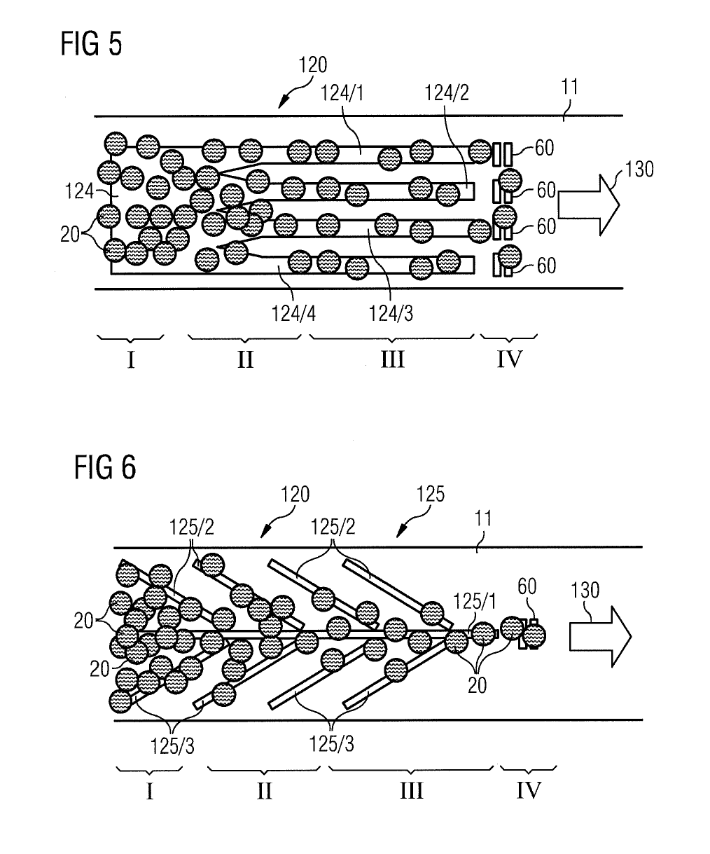

FIG. 5 shows a fourth exemplary embodiment. The flow strip 124 shown here is, like the examples of FIGS. 2 and 3, of comparatively wide construction on the input side, i.e. in zone I. The single, wide flow strip 124 is, however, divided into four flow sub-strips 124/1 to 124/4, over which the cells 20 are guided to the sensors 60, as in the previous exemplary embodiments.

FIG. 6 shows a fifth exemplary embodiment of the cell-guiding device 120. In this case, the flow strips 125 are arranged in a herringbone pattern, i.e. a central flow strip 125/1 is on the one hand provided which extends to the sensor 60. Further flow strips 125/2, 125/3 are on the other hand provided, which are arranged at an angle of for example ±45° to the direction of flow 130, such that the magnetically labeled cells 20 are initially guided to the central flow strip 125/1 and thence over the sensor 60.

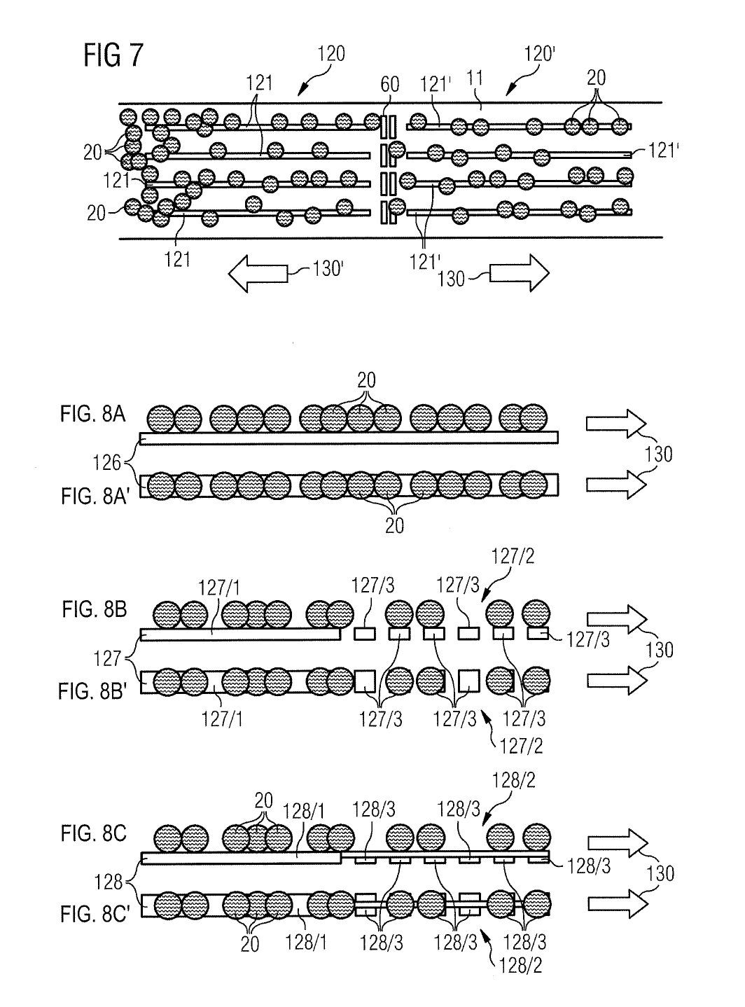

FIG. 7 shows an embodiment which, with regard to the arrangement of the flow strips 121, corresponds in principle to that of FIG. 2. Unlike FIG. 2, however, flow strips 121, 121′ are in this case arranged both upstream and downstream of the sensors 60 in the direction of flow. In a corresponding detection method, the medium and thus the labeled cells 20 would be conveyed alternately in a first direction of flow 130 and in the opposite direction 130′, for example in order to improve the statistics. The cells 20 accordingly brush repeatedly over the sensors 60.

In principle, the embodiment of FIG. 7 with a cell-guiding device arranged on both sides of the sensors 60 may, of course, also be constructed in accordance with the embodiments of the cell-guiding devices of FIGS. 3 to 6. However, since the cells 20 passing over the sensor 60 are generally already ordered, i.e. no longer stochastically distributed, it is generally sufficient to construct the further cell-guiding device 120′ as shown in FIG. 7. A kind of “collector”, as the cell-guiding devices 120 in particular of FIGS. 3, 4 and 5 in zone I which primarily serve to guide the stochastically distributed cells 20 towards the individual tracks, would only be necessary in the case of the further cell-guiding device if it were possible to supply a medium to the flow chamber 10 both via the orifice 40 and via the orifice 50.

FIGS. 8A to 8C′ show various embodiments of individual flow strips. The figures provide a side view and a plan view of the flow strip of each embodiment with magnetically labeled cells 20 arranged thereon.

The flow strip 126 of FIG. 8A is of continuous construction, as also shown in FIGS. 1 to 7.

FIG. 8B, in contrast, shows discontinuous flow strip 127. In the upstream part 127/1 in the direction of flow 130, the strip is likewise of continuous construction. The downstream part 127/2 of the flow strip 127 is, however, discontinuous, i.e. the strip is here divided into a plurality of portions 127/3 arranged downstream of one another. As described above, this has an advantageous effect on the possibility of individual cell detection. The length of the individual portions 127/3 may for example correspond to the width of the strip and/or approximately to the diameter of the cell.

The flow strip 128 of FIG. 8C substantially corresponds to that of FIG. 8B, i.e. an upstream, continuous part 128/1 and a downstream, discontinuous part 128/2 with individual portions 128/3 are provided. In addition, however, a continuous strip 128/4 is applied onto the portions 128/3, which continuous strip for example prevents cells 20 being diverted into the zones between the portions 128/3 by any turbulence in the flow.

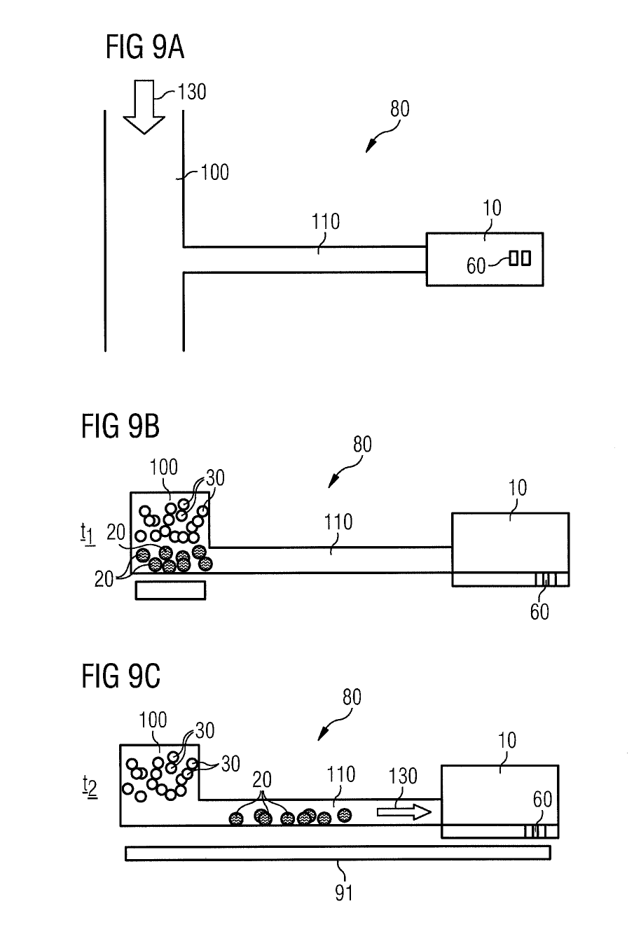

FIG. 9 illustrates the principle of concentration in simplified manner. FIG. 9A here shows a plan view of the concentration device 80, while FIGS. 9B and 9C show two side views or cross-sections of the device 80 at successive points in time t1, t2 (t2>t1). Typically, the concentration of the magnetically labeled cells 20 is comparatively low in the original medium, for example whole blood. Analysis would be very time-consuming. The original medium, which flows through a channel 100 in the concentration device 80, is therefore concentrated before detection, the intention being to increase the proportion of labeled cells 20 in the medium relative to the proportion of unlabeled cells 30.

FIG. 9 illustrates “semi-continuous” concentration, in which the concentration proceeds first at time t1 (cf. FIG. 9B) and then the concentrated medium is conveyed to the flow chamber at time t2 (FIG. 9C). Further concentration (not shown) would then proceed etc.

Concentration is performed using a magnet 90 which generates a first magnetic field (not shown) of an order of magnitude of approx. 100-1000 mT. This attracts the magnetically labeled cells 20 onto the side of the channel 100 on which the magnet 90 is arranged. Accordingly, the concentration of labeled cells 20 is distinctly increased on this side of the channel 100. It is specifically on this side that a further channel 110 is furthermore provided, via which the now concentrated medium reaches the flow chamber 10, which is shown only symbolically in FIG. 9. In order to keep the magnetically labeled cells 20 also in the channel 110 and finally in the flow chamber 10 on the side on which the sensor 60 is also positioned, a further magnet 91 is provided, which however generates a weaker magnetic field than the magnet 90, for example of an order of magnitude of up to 100 mT.

The method which may be performed with the flow chamber described above is intended for use for example for mammalian cells, microorganisms or magnetic beads. Magnetic flow cytometry may be used in combination with optical (for example fluorescence, scattered light) or other non-magnetic detection methods (for example radiochemical, electrical) in order to perform in situ observations or carry out further analyses.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-12. (canceled)

13. A flow chamber of a flow cytometer, having an internal surface and through which a medium carrying magnetically labeled cells may flow, comprising:
at least one sensor positioned on the internal surface of the flow chamber to detect cells; and
a cell-guiding device, at least one of magnetic and magnetizable, positioned upstream of said at least one sensor in a direction of flow and arranged and constructed to guide the magnetically labeled cells over said at least one sensor.

14. The flow chamber as claimed in claim 13, wherein said cell-guiding device is arranged on the internal surface of the flow chamber and includes at least one flow strip, at least one of magnetic and magnetizable, oriented substantially parallel to the direction of flow, each of the at least one flow strip having a corresponding sensor and guiding magnetically labeled cells over the corresponding sensor.

15. The flow chamber as claimed in claim 14, wherein the at least one flow strip has a constant width throughout the direction of flow.

16. The flow chamber as claimed in claim 14, wherein the at least one flow strip tapers in the direction of flow, forming one of a funnel and a half funnel.

17. The flow chamber as claimed in claim 14, wherein the at least one flow strip includes a plurality of flow strips arranged in a herringbone pattern.

18. The flow chamber as claimed in claim 13, wherein said cell-guiding device is a single, wide flow strip arranged on the internal surface of the flow chamber, at least one of magnetic and magnetizable, subdivided in the direction of flow into a plurality of substantially parallel flow sub-strips, each having a corresponding sensor and guiding magnetically labeled cells over the corresponding sensor.

19. The flow chamber as claimed in claim 13, wherein the at least one flow strip has a downstream part subdivided into a plurality of portions lying downstream of one another and spaced apart from one another.

20. The flow chamber as claimed in claim 13, further comprising a magnet arranged to direct a force, towards the internal surface of the flow chamber, acting on the magnetically labeled cells.

21. The flow chamber as claimed in claim 20, wherein said at least one sensor is a giant magnetoresistance sensor.

22. The flow chamber as claimed claim 13, further comprising another magnetic or magnetizable cell-guiding device positioned downstream of said sensor in the direction of flow.

23. A method for detecting magnetically labeled cells in a medium flowing through a flow chamber of a flow cytometer, comprising:
guiding the magnetically labeled cells while flowing, over a sensor by a first cell-guiding device, magnetic or magnetizable, positioned upstream of the sensor in a first direction of flow.

24. The method as claimed in claim 23, wherein a another cell-guiding device is arranged downstream of the sensor in the first direction of flow,
wherein said guiding includes guiding the medium over the sensor alternately in the first direction of flow and in a second direction of flow , opposite to the first direction of flow.
